(19) United States
(12) Patent Application Publication
(10) Pub. No.: US 2019/0323508 A1
(43) Pub. Date: Oct. 24, 2019

(54) SOLAR POWERED IRRIGATION APPARATUS

(71) Applicant: KHETHWORKS PRIVATE LIMITED, Pune (IN)

(72) Inventors: Kevin SIMON, Somerville, MA (US); Katherine TAYLOR, Washington, DC (US)

(21) Appl. No.: 16/475,063

(22) PCT Filed: Nov. 22, 2017
(86) PCT No.: PCT/IN2017/050552

§ 371 Date: Jun. 28, 2019

(30) Foreign Application Priority Data
Dec. 30, 2016 (IN) 201621045077

(51) Int. Cl. F04D 13/08; F04D 1/00; F04D 13/06; F04D 29/02; H02K 5/132; H02K 7/14; H02K 11/00; H02K 11/30; H02S 10/20; H01M 10/0525

(52) U.S. Cl. CPC F04D 13/086; F04D 1/00; F04D 13/0606; F04D 13/068; F04D 29/026; A01G 25/00; H02K 7/14; H02K 11/0094; H02K 11/30; H02S 10/20; H01M 10/0525; H02K 5/132

(57) ABSTRACT

The present disclosure relates to the field of apparatus used in agriculture and irrigation. The existing solutions available with small acreage farmers having access to shallow groundwater are too large or too small in capacity as compared to the size of the farms and have designs which are complicated or unnecessarily expensive. The present disclosure envisages an apparatus (100) which is environment friendly, economical, compact and requires minimum human intervention for operation. The apparatus of the present disclosure (100) has components having dimensions derived from a target specific speed ranging from 600 to 2000 (US units—rpm, gpm, ft) making the apparatus (100) most suitable and efficient for the afore-stated application.

### FIELD

The present disclosure relates to a solar powered irrigation apparatus.

### Definitions

The term ‘impeller speed’, for the purpose of the present disclosure, is defined as the speed at which the impeller rotates.

The term ‘specific speed’, for the purpose of the present disclosure, is defined as an index used for predicting the desired pump performance and for characterizing pumping conditions. The parameter ‘specific speed’ may be used to determine the most appropriate pump design for a given application. The term specific speed as used in the present disclosure is according to US units (rpm, gpm, ft).

The term ‘target specific speed’, for the purpose of the present disclosure, is defined as the estimated speed at which the pump gives maximum efficiency.

The term ‘impeller inlet radius’, for the purpose of the present disclosure, is defined as the radius of the inlet of an impeller, where a fluid gets sucked into the impeller.

The term ‘impeller head coefficient, for the purpose of the present disclosure, is defined as the ratio between generated pressure and the square of the impeller tip speed.

The term ‘impeller outlet radius’, for the purpose of the present disclosure, is defined as the circumference of the impeller, where the water flows out of the impeller into the accumulator.

The term ‘impeller outlet height/width’, for the purpose of the present disclosure, is defined as the height of the outlet of the impeller, where the water leaves the impeller.

The term ‘Best Efficiency Point (BEP)’, for the purpose of the present disclosure, is defined as the point on a pump curve that yields the most efficient operation.

The term ‘operation time’, for the purpose of the present disclosure, is defined as the amount of time the apparatus is used each day.

The term ‘solar power requirement’, for the purpose of the present disclosure, is defined as the required solar panel size for the solar panel and the apparatus of the present disclosure to successfully support year-round irrigated agriculture.

The term ‘pressure head’, for the purpose of the present disclosure, is defined as a measurement of the height of a liquid column, a pump could create from the kinetic energy the pump gives to the liquid. The term pressure head is expressed in units of height such as meters or feet.

The term ‘flow rate’, for the purpose of the present disclosure, is defined as is the volume of liquid that travels through the pump in a given time (measured in gallons per minute or gpm).

### BACKGROUND

Irrigation is a technique dated back to the ancient Egyptians and Nubians for providing controlled supply of water for purposes such as agriculture, especially during periods of inadequate rainfall. Techniques and apparatuses for irrigation have extensively evolved over the years. Techniques such as Basin irrigation, Terrace irrigation have been replaced by drip irrigation, sprinkle irrigation and sub-irrigation.

For most of the afore-stated techniques, water needs to be made available at the ground level. Typically, pumps carry out the function of drawing water from wells below ground level and have it reach the ground level and beyond. Operation of such pumps often requires use of conventional energy resources as the fuel. As an effort to reduce the environmental footprint, certain non-conventional energy resources such as solar energy have been harnessed. However, most of the current solar power-based pumps are designed for extensively large farms that have access to deep groundwater levels and require a high flow rate. The high flow rate and design pressure of such pumps increase the total system cost, making solar irrigation unaffordable for small acreage farmers. Furthermore, such pumps have too large or too small capacities as compared to the size of the farms and designs which are too complicated or unnecessarily expensive.

The present disclosure envisages a solar powered apparatus for use in irrigation by small acreage farmers having access to shallow groundwater; the apparatus being compact, environment friendly, economical and requiring minimum human intervention for operation. As a virtue of the apparatus of the present disclosure, small acreage farmers would have better control over their livelihoods.

### OBJECTS

It is an object of the present disclosure to provide a solar powered irrigation apparatus.

It is another object of the present disclosure to provide a solar powered irrigation apparatus for use in small acreage farms having access to shallow groundwater.

It is yet another object of the present disclosure to provide a solar powered irrigation apparatus which has a small environmental footprint.

It is still another object of the present disclosure to provide a solar powered irrigation apparatus which is economical.

It is yet another object of the present disclosure to provide a solar powered irrigation apparatus which is compact and simple, yet incorporates high quality technology.

It is still another object of the present disclosure to provide a solar powered irrigation apparatus which requires minimum human intervention for operation.

It is yet another object of the present disclosure to provide a solar powered irrigation apparatus which requires very low supply of energy.

It is still another object of the present disclosure to provide a solar powered irrigation apparatus which will give small acreage farmers better control over their livelihoods.

### SUMMARY

The present disclosure provides a solar powered irrigation apparatus (100) comprising at least one volute inlet (102), an impeller (104), an accumulator (106), a motor (110), a housing (112), at least one component selected from the group consisting of a printed circuit board, an electronic speed controller, a battery (118) and electronics mount(s) (120), a volute plate (122), a back plate (124) and at least one cord grip (126, 128) adapted to hold at least one cord selected from the group consisting of power cable cord to connect to at least one solar panel and communication cable cord to connect to an on-off switch. Typically, the dimensions of the afore-stated components are derived from a target specific speed ranging from 600 to 2000 (US units—rpm, gpm, ft) making the apparatus most suitable and efficient for use in small acreage farms having access to shallow ground water. Typically, the apparatus of the present disclosure (100) is a submersible centrifugal pump having a solar power requirement of less than 350 Watts, preferably from 180 to 350 Watts.

### BRIEF DESCRIPTION OF THE ACCOMPANYING DRAWINGS

The solar powered irrigation apparatus of the present disclosure (100) is explained with the help of the following non-limiting drawings.

FIG. 1 illustrates a cross-sectional view of the entire length of the apparatus of the present disclosure (100).

FIG. 2 illustrates a cross-sectional isometric view of the top portion of the apparatus of the present disclosure (100).

FIG. 3 illustrates an isometric view of the entire apparatus of the present disclosure (100).

FIG. 4 is an illustration of the fluid dynamics in the top portion of the apparatus of the present disclosure (100).

### DESCRIPTION

The present disclosure describes a solar powered irrigation apparatus (100). The apparatus of the present disclosure (100) has been specifically designed for farms having an area ranging from 0.25 to 3 acres and having access to groundwater ranging from 0 to 17 meters below ground level (m bgl).

In one embodiment, the apparatus of the present disclosure (100) is a pump to be used for irrigation purposes. In another embodiment, the apparatus of the present disclosure (100) is a centrifugal pump to be used for irrigation purposes in small acreage farms having access to shallow groundwater.

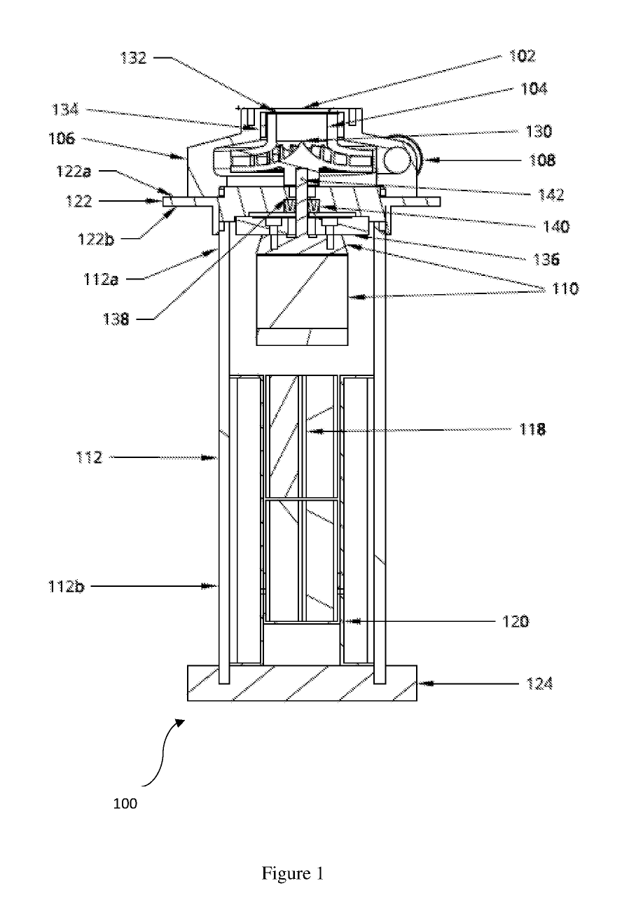

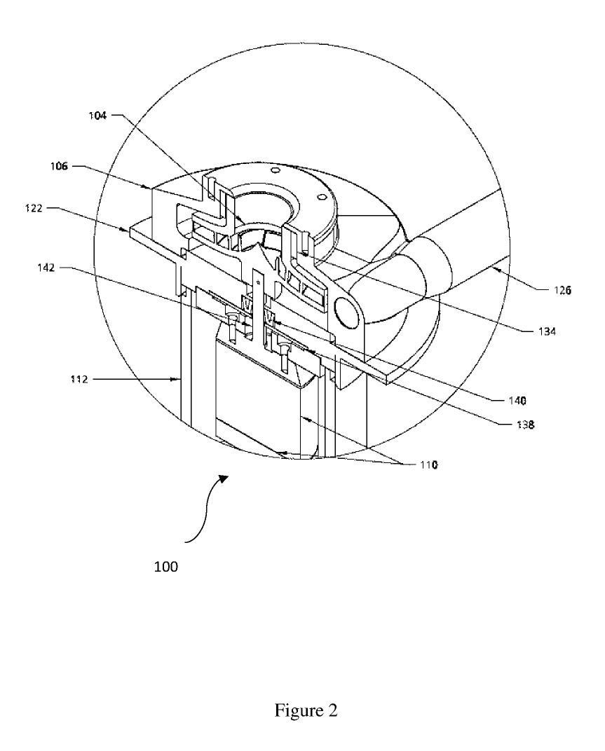

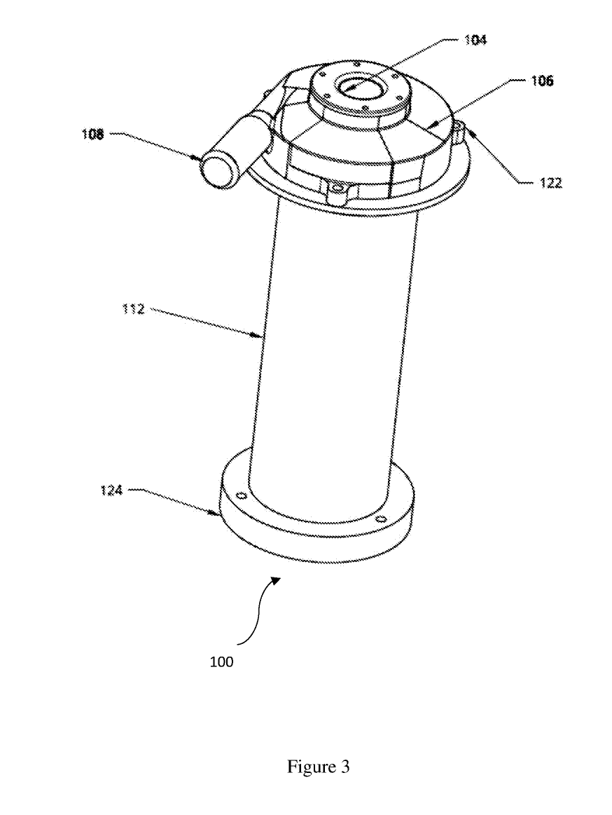

The apparatus of the present disclosure (100) is illustrated in FIGS. 1, 2, 3 and 4. FIG. 1 is a cross-sectional view of the entire length of the apparatus of the present disclosure (100) and will be referred to hereinafter to describe the organization or arrangement of the components in the apparatus. The apparatus of the present disclosure (100) comprises the components described hereinafter.

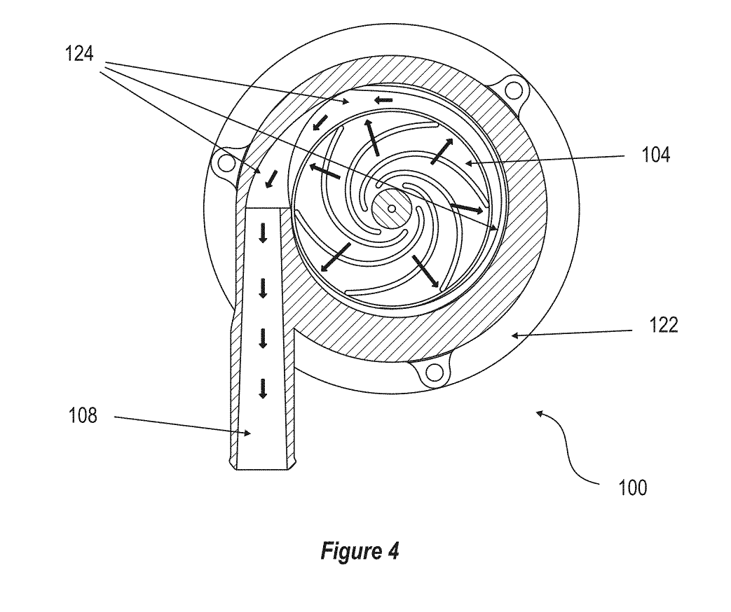

The top portion of the apparatus of the present disclosure (100) bears at least one volute inlet (102), through which, at least one fluid is channeled into the apparatus (100); thereby pressurizing the fluid. Typically, the fluid of the present disclosure is water. As a virtue of the geometry of the apparatus (100) and the mechanics of the system, the pressurized fluid thus taken in is conveyed to the eye of an impeller (130). The eye of an impeller (103) is the central point along the axis of the impeller (104). Typically, an impeller (104) is a rotor used to increase the pressure and flow of a fluid. Therefore, on coming in contact with the pressurized fluid conveyed by the volute inlet (102), the rotational movement of the impeller (104) causes the fluid to keep getting sucked in and later get centrifugally discharged into an accumulator (106), thereby further pressurizing the fluid. The dynamics of the fluid from the impeller (104) to the accumulator (106) are illustrated in FIG. 4 where the black solid arrows within the figure indicate movement of the fluid. The impeller (104) of the present disclosure is a closed type of impeller (104) and is housed co-axially and concentrically within the accumulator (106). Typically, a gap ranging from 0.001 to 0.020 inches exists in between the volute inlet (102) and the top of the impeller (104) by placing two thin wear rings (132) in between the impeller top (104) and the volute inlet (102). Typically, the wear rings (132) are made up of at least one low-friction material selected from the group consisting of brass and bronze. The range 0.001 to 0.020 inches has been optimized to avoid friction on one hand and water leakage on the other.

In accordance with the present apparatus, the volute inlet (102) is a part of the accumulator (106). As can be seen in FIG. 1, the male part of the impeller (104) fits into the female part of the accumulator (106), just below the volute inlet (102) by means of bushing (134). The bushing (134) is inserted into the female part of the accumulator (106) to provide a bearing surface for the efficient rotary motion of the impeller (104).

The accumulator (106) of the present disclosure is the circular component housed co-axially and concentrically around the impeller (104) and is adapted to receive the centrifugally discharged pressurized fluid and channel the fluid to an outlet nozzle (108). Typically, the accumulator (106) has an area sized to maintain a constant radial momentum as flow accumulates around the impeller (104) until a full revolution is completed and the flow exits into the outlet nozzle (108). The outlet nozzle (108) is a continuation of the accumulator (106) and connects to a discharge pipe (not shown in the figures) which carries the pressurized fluid to the desired destination. Typically, the cross-sectional area of the outlet nozzle (108) scales linearly with the length of the outlet nozzle (108).

The impeller (104), accumulator (106) and outlet nozzle (108) are made up of at least one material selected from the group consisting of ultra-high molecular weight polyethylene (UHMWPE), aluminum, propylene, high density polyethylene (HDPE), polyvinyl chloride (PVC), Acrylonitrile butadiene styrene (ABS) and polylactic acid (PLA) which makes the present apparatus highly efficient and economical.

The apparatus of the present disclosure (100) is placed into the water reservoir from which water is to be supplied for irrigation. As soon as it is switched on, the impeller (104) starts rotating. As a consequence, the water surrounding the exposed part of the impeller (104) (the eye of the impeller (130)) also starts rotating. This imparts centrifugal force to the water particles and the water particles move radially outwards into the accumulator (106). Since the rotational mechanical energy of the impeller (104) is transferred to the water moving radially out, the pressure and kinetic energy of the water moving out increases. At the eye of the impeller (130), water is getting displaced, and therefore, a negative pressure is induced. As a virtue of the negative pressure, water from the reservoir keeps getting sucked in and the apparatus (100) keeps discharging pressurized water to the desired destination.

The apparatus of the present disclosure (100) incorporates a motor (110) to drive the impeller (104). The motor (110) of the present disclosure is selected from the group consisting of brushless DC motor or brushed DC motor. In one embodiment, the no load current of the motor is 0.8 A at 30 V and 4,750 rpm. In another embodiment, the rated load of the motor is 0.9 N-m at 4,000 rpm, 14 A and 30V. In accordance with the present disclosure, the motor (110) derives the electrical energy required for operation through the solar panel.

The apparatus of the present disclosure (100) further comprises a printed circuit board (PCB), an electronics speed controller (ESC) and optionally, a battery (118). The PCB and ESC can be mounted anywhere inside the housing (112) and are typically mounted on the back side of an electronics mount (120). The electronics mount (120) is a metal frame that holds the PCB, ESC and battery (118) in order to avoid displacement of the afore-stated components within the apparatus body.

The PCB performs a wide array of functions that include but are not limited to balancing the battery (118) (when to charge, when to discharge), controlling the apparatus (100) (such as sending pulse width modulation signal to the ESC), determining what speed to operate the impeller (104) at and making decisions on when to switch the apparatus on and off. The PCB also has certain specialized sensors to carry reading errors and obtain performance data. Characteristically, the PCB automates the entire operations of the apparatus (100). A farmer can walk out in the morning, drop the apparatus (100) in the water, press the “on” button and leave it for the entire day. During that day, there will be periods of time when the apparatus (100) is discharging water and periods when it is not. During the period, the apparatus (100) is discharging water, the battery (118) gets used up and the period during which the apparatus (100) is not discharging water, the battery (118) gets charged from the solar panels. All the afore-mentioned activities are controlled by the PCB. The farmer does not need to manually make any adjustment as the automation is programmed into the PCB. Therefore, the PCB makes the apparatus of the present disclosure (100) work with minimum human intervention.

The ESC is an electronic circuit typically associated with a brushless motor and adapted to vary the speed and direction of the motor (110). The ESC essentially provides an electronically generated three-phase electric power low voltage source of energy for the motor (110) to function effectively.

The apparatus of the present disclosure (100) optionally includes a battery (118). Typically, the battery (118) is made up of a small, light and high charging current density material. In one embodiment, the battery (118) used in the present apparatus (100) is a Lithium-polymer battery. In another embodiment, the battery (118) used in the present apparatus (100) is a lithium iron phosphate (LiFePO₄) battery. Typically, the LiFePO₄ battery is rechargeable and uses LiFePO₄ as a cathode material. Further, a LiFePO₄ battery is associated with advantages such as being low cost, non-toxic, having excellent thermal stability, safety characteristics, electrochemical performance and specific capacity. During day-time when the sun is shining, the apparatus of the present disclosure (100) derives the energy required to function directly from the solar panels (not shown in figures). When there is no sunlight, the apparatus of the present disclosure (100) derives the energy required to function from the battery (118).

The apparatus of the present disclosure (100) further comprises a housing (112) for housing and protecting the motor (110), the printed circuit board, the motor (110), the ESC and if present, the battery (118). Typically, the housing (112) has an upper end (112a) and a lower end (112b).

The apparatus of the present disclosure (100) still further comprises a volute plate (122) having a top end (122a) and a bottom end (122b). The top end (122a) of the volute plate (122) is adapted to mount the impeller (104) and the accumulator (106) and the bottom end (122b) of the volute plate (122) is adapted to mount the motor (110) and the upper end of the housing (112a). The motor (110) is mounted on a motor mounting plate (136) and the motor mounting plate (136) is in turn affixed to the bottom end of the volute plate (122b) by means of a retaining ring (138) and a seal (140). The seal (140) used in the present position is at least one selected from the group consisting of axial mechanical seal and radial seal. In one embodiment, the seal (140) used in the present position is a U-cup seal. A motor shaft (142) extending from the motor mounting plate (136), passes through the volute plate (122) and attaches to the impeller (104). The apparatus of the present disclosure (100) still further comprises a back plate (124) operatively coupled with the lower end of the housing (112b).

The apparatus of the present disclosure (100) further includes at least one power cable cord (not shown in the figures) which connects to at least one solar panel and at least one communication cable cord (not shown in the figures) which connects to an on-off switch (not shown in the figures). In one embodiment, the power cable cord and the communication cable cord can be combined to form a single cable which exits the apparatus (100). Consequently, the apparatus of the present disclosure (100) has at least one cord grip to hold the power cable cord independently (126) or the communication cable cord independently (128) or the combined power and communication cable. The afore-mentioned cord grip (126, 128) is affixed to at least one component selected from the group consisting of the back plate (124) and the housing (112). In one embodiment, the cord grip (126, 128) comes out of the side of the housing (112).

The geometry of the apparatus of the present disclosure (100) has been specifically designed for farms having an area ranging from 0.25 to 3 acres and having access to groundwater ranging from 0 to 17 meters below ground level (m bgl)—for small acreage farms having access to shallow groundwater. The inventors have accurately assessed the yearly energy requirements for small acreage farmers having access to shallow groundwater and matched the same with the geometry of the hydraulic components to efficiently deliver the required energy each day as the sun shines with minimal wastage. Keeping in mind the afore-stated application of the apparatus (100), the inventors of the present disclosure have identified a target pressure head of 10 meters and a target flow rate of 1 liters per second. On the basis of the afore-stated target pressure head and target flow rate, the inventors have established the impeller speed, using the following Equation 1:

$$η = 0.94 - 0.08955 {[ \frac{Q ( gpm )}{N ( rpm )} X ]}^{- 0.21338} - 0.29 {[ {log}_{10} ( \frac{2286}{{N}_{s}} ) ]}^{2}$$

where:
η: target specific speed
Q (gpm): flow rate or capacity, ft³/sec
N (rpm): rotative speed of the impeller, rpm
Nₛ: specific speed in rpm, gpm, ft units
X=[140/ε(μ-in.)]²

The impeller speed is set by treating the impeller speed as a variable and finding the value which optimizes efficiency (η, the variable on the left). Typically, the impeller speed of the apparatus of the present disclosure (100) ranges from 3000-4500 rpm.

Upon establishing the impeller speed, the specific speed of the apparatus (100) has been identified using the following equation:

Ωₛ=Ω\sqrt{Q}÷(gΔH)^{3/4} Equation 2

N_{s{U.S.}}=N (rpm)\sqrt{Q} (rpm)÷(ΔH {ft.})¾=Ωs×2733 Equation 3
where:
Ωₛ: specific speed
Ω: angular speed of the impeller in radians per second
N_{s{U.S.}}: specific speed in US/Imperial units (rpm, gpm, ft units)
N (rpm): rotative speed of the impeller, rpm
Q: flow rate or capacity, ft³/sec
g: acceleration due to gravity in m/s²
ΔH: pressure head in feet

The impeller speed and the specific speed being established and the flow and pressure head known, the inventors of the present disclosure have arrived at the target specific speed using Equation 1 reproduced below.

$$η = 0.94 - 0.08955 {[ \frac{Q ( gpm )}{N ( rpm )} X ]}^{- 0.21338} - 0.29 {[ {log}_{10} ( \frac{2286}{{N}_{s}} ) ]}^{2}$$

where:
η: target specific speed
Q(gpm): flow rate or capacity, ft Vsec
   N (rpm): rotative speed of the impeller, rpm
   Nₛ: specific speed in rpm, gpm, ft units
   X=[140/ε(μ-in.)]²

On the basis of the target specific speed, other parameters and dimensions of the apparatus (100) have been optimized as provided hereinafter.

The impeller inlet radius has been set using Equation 4:

$${r}_{e} = {[ \frac{Q}{πΩφ {\text{?}}_{\text{?}} ( 1 - \frac{\text{?}}{{r}_{\text{?}}^{2}} )} ]}^{1 / 3}$$

$$\text{?} \text{indicates text missing or illegible when filed}$$

where
rₑ: impeller inlet radius in meters
Q: flow rate or capacity, ft³/sec
Π=3.142
Ω: target specific speed
φₑ=0.3
rₛ=0

Here, rₛ is the radius of the center of the impeller that blocks the impeller eye (130). The inventors have set this to 0 since the impeller inlet is unobscured.

The impeller head coefficient has been set using the target specific speed and the Equation 5:

Hc=0.4/Ω^{0.25}
where:
Hc: Head coefficient
Ω: target specific speed

The impeller outlet radius has been set using the head coefficient and the target specific speed using Equation 6:

rₒ=[g*ΔH/(Ω²*Hc)]^{0.5}
where
rₒ: impeller outlet radius in meters
g: acceleration due to gravity in m/s²
ΔH: pressure head in feet
Ω: target specific speed
Hc: Head coefficient

The blade angle has been set to 22.5. With the impeller outlet radius set and a blade angle picked, the outlet velocity is set using Equation 7:

V=U*psi
where
V: outlet velocity in meters/sec
U: Tip velocity in meters/sec
psi: Flow coefficient; psi=tan(blade angle)

U=N (rpm)*rₒ Tip velocity: Equation 8
where:
N (rpm): rotative speed of the impeller, rpm
rₒ: impeller outlet radius in meters

The impeller outlet width/height is then established to give the desired flow rate using Equation 9:

Hₒ:Q/(V*2*Π*rₒ)
where
Hₒ: Outlet width/height in meters
Q: flow rate or capacity, ft³/sec
V: outlet velocity in meters/sec
Π=3.142
rₒ: impeller outlet radius in meters

Thus, the dimensions of the impeller (104) such as the impeller inlet radius, the impeller head coefficient, impeller outlet radius, impeller blade angle, impeller outlet width/height have been derived from the target specific speed (600 to 2000, U.S units), which in turn has been derived from the flow rate and pressure head specific to farms having an area ranging from 0.25 to 3 acres and having access to groundwater ranging from 0 to 17 meters below ground level (m bgl), making the apparatus (100) most efficient and suitable for this application. Further, the dimensions of other components such as the volute inlet (102), the accumulator (106), the housing (112), the volute plate (122) and the black plate (124) have been derived from the afore-stated dimensions of the impeller (104). Still further, the best efficiency performance of the motor (110) such as power, torque, rpm has been matched with the best efficiency performance of the impeller (104) in order to make the apparatus of the present disclosure (100), most efficient.

The apparatus of the present disclosure (100) is a submersible centrifugal pump. The apparatus (100) has a full range of operation with pressure ranging from 0.1 to 170 kPa. The Best Efficiency Point (BEP) of the apparatus (100) is at a pump pressure ranging from 80 to 120 kPa and flow rate ranging from 0.6 to 1.3 liters per second. The operation time of the apparatus of the present disclosure (100) ranges from 3 to 8 hours per day. In one embodiment, the apparatus of the present disclosure (100) can give 5 hours of continuous water supply.

The low power draw coupled with an efficient geometry for the low power draw enables the use of less than 350 Watts of solar power to drive the system, making the present apparatus (100) much cheaper than the apparatuses claimed in the prior art. Typically, the solar power requirement of the apparatus of the present disclosure (100) is less than 350 Watts, preferably from 180 to 350 Watts.

The embodiments described herein above are non-limiting. The foregoing descriptive matter is to be interpreted merely as an illustration of the concept of the present disclosure and it is in no way to be construed as a limitation.

Description of terminologies, concepts and processes known to persons acquainted with technology has been avoided to preclude beclouding of the afore-stated embodiments.

### TECHNICAL ADVANTAGES AND ECONOMIC SIGNIFICANCE

The technical advantages and economic significance of the apparatus of the present disclosure (100) are presented herein after:
Requires minimum human intervention for operation
Runs on solar energy and is therefore economical
Runs on very low supply of energy and is therefore economical
Made up of cheap, commonly available raw materials
Compact and simple, yet incorporates high quality technology.

1. A solar powered irrigation apparatus comprising:
a. at least one volute inlet adapted to channelize and pressurize at least one fluid from the outside of said apparatus to the inside of said apparatus;
b. an impeller adapted to rotate and suck in said pressurized and channeled fluid and further pressurize said fluid by centrifugally discharging said fluid;
c. an accumulator housed co-axially and concentrically around said impeller, having an area sized to maintain a constant radial momentum and adapted to receive said centrifugally discharged fluid and channel said centrifugally discharged fluid to an outlet nozzle;
d. a motor adapted to drive said impeller;
e. a housing, having an upper end and a lower end;
f. a volute plate, having a top end and a bottom end, adapted to mount said impeller and said accumulator at said top end and said motor and said upper end of the housing at said bottom end;
g. a back plate operatively coupled with said lower end of the housing;
wherein the dimensions of the components (a) to (g) are derived from a target specific speed ranging from 600 to 2000.

2. The apparatus as claimed in claim 1, being a submersible centrifugal pump.

3. The apparatus as claimed in claim 1, adapted for use in farms having an area ranging from 0.25 to 3 acres and having access to groundwater ranging from 0 to 17 meters below ground level.

4. The apparatus as claimed in claim 1, wherein a gap ranging from 0.001 to 0.020 inches exists in between said volute inlet and the top of said impeller.

5. The apparatus as claimed in claim 1, wherein said impeller, accumulator and outlet nozzle are made of at least one material selected from the group consisting of ultra-high molecular weight polyethylene (UHMWPE), aluminum, propylene, high density polyethylene (HDPE), polyvinyl chloride (PVC), Acrylonitrile butadiene styrene (ABS) and polylactic acid (PLA).

6. The apparatus as claimed in claim 1, wherein the cross-sectional area of said outlet nozzle scales linearly with the length of said outlet nozzle.

7. The apparatus as claimed in claim 1, wherein said motor is a brushless DC motor or brushed DC motor.

8. The apparatus as claimed in claim 1, further comprising a battery, said battery comprising a high charging current density material.

9. The apparatus as claimed in claim 8, wherein said battery is a Lithium-polymer battery or a lithium iron phosphate battery.

10. The apparatus as claimed in claim 1, having a Best Efficiency Point (BEP) at a pump pressure ranging from 80 to 120 kPa and flow rate ranging from 0.6 to 1.3 liters per second.

11. The apparatus as claimed in claim 1, said apparatus having a solar power requirement less than 350 Watts.

12. The apparatus as claimed in claim 1, wherein said fluid is water.

13. The apparatus as claimed in claim 11, said apparatus having a solar power requirement between 180 to 350 Watts.

14. The apparatus as claimed in claim 1, further comprising:
a cord grip affixed to said back plate or said housing, said cord grip adapted to hold at least one cord selected from the group consisting of a power cable cord to connect to at least one solar panel and a communication cable cord adapted to connect to an on-off switch.

15. The apparatus as claimed in claim 1 further comprising a printed circuit board.

16. The apparatus as claimed in claim 1 further comprising an electronic speed controller adapted to vary the speed and direction of said motor.

17. The apparatus as claimed in claim 1 further comprising a printed circuit board, an electronic speed controller and an electronics mount adapted to mount said printed circuit board and said electronic speed controller.

18. The apparatus as claimed in claim 1, further comprising a printed circuit board, a battery, an electronic speed controller and an electronics mount, wherein said housing is adapted to house at least one component selected from the group consisting of said motor, said printed circuit board, said electronic speed controller, said battery and said electronics mount.

19. The apparatus as claimed in claim 1, wherein said impeller, accumulator and outlet nozzle are made of a metal.

20. The apparatus as claimed in claim 19 wherein the metal is aluminum.

21. The apparatus as claimed in claim 1, wherein said impeller, accumulator and outlet nozzle are made of a plastic material.

22. The apparatus as claimed in claim 21 wherein the plastic material is chosen from the group consisting of ultra-high molecular weight polyethylene (UHMWPE), propylene, high density polyethylene (HDPE), polyvinyl chloride (PVC), Acrylonitrile butadiene styrene (ABS) and polylactic acid (PLA).
